(19) United States
(12) Patent Application Publication
(10) Pub. No.: US 2007/0193823 A1
(43) Pub. Date: Aug. 23, 2007

(54) Emergency exit window with anti-stealage function

(76) Inventor: Chun-N Tseng, Tao-Yuan (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 11/341,388

(22) Filed: Jan. 30, 2006

(51) Int. Cl. E05B 65/10; A62B 1/16

(52) U.S. Cl. 182/3; 49/141; 52/73

(57) ABSTRACT

The present invention is aimed to provide an emergency exit window with anti-stealage function, which is suitable for apartments, or buildings, it comprises a grill structure secured to a wall of a building, a foldable T-type grill incorporated within the grill structure, the T-type grill can be folded as a cage-like device and an escape sling installed in the interior, which has steel cable in connection with the foldable T-type grill. The foldable T-type grill consists of a middle fixed portion and two pivotally foldable doors at two ends. The spread out T-type grill is a complement to the metal grill structure, and the T-type grill can be locked up with the grill structure. Therefore, they are assembled to form an emergency exit window. When the user trapped in an emergency accident, they may escape from the fire, or accidental events from the emergency exit window.

### FIELD OF THE INVENTION

The present invention is related to an emergency exit window with bars to keep off the thieves get into the house, as a foldable cage-like escape sling is incorporated with the window, when emergency events such as fire happens, the users can sit into the cage escape from the scene of an accident.

### BACKGROUND OF THE INVENTION

In general, the conventional doors or windows made of aluminum mainly used for anti-stealage. When happening with fire alarm, the window may be a hindrance to an emergency exit, it may cause colossal loss about lives, properties. The persons skilled in the art have provided a lot of windows with emergency exit functions. Usually, an extendable ladder structure can be developed from the window to the ground, for the users climbing down.

Such as U.S. Pat. No. 5,971,105 entitled “Escape ladder” assigned to Harold Jacobson on Oct. 26, 1999. In which, individual steps are spanned apart from the wall by integral spacers. A sufficient room is required for each nested step, when climbing down the ladder, but under panic situation, a user may hurriedly stomp once two or three steps or more down the ladder, it may result in the entanglement of the foot with the collapsible steps. U.S. Pat. No. 5,893,235 entitled “Removable security apparatus for building opening” assigned to Gary L. Almond on Apr. 13, 2005. In which, grill structure may be removed from opening and positioned outside the building to facilitate egress through opening. At least, a chain and extenders are necessitated for supporting grill along the building. Though the supports can be made in telescoping or sliding relationship with the frame, but the extended length is limited, and the escaped person is totally exposed out of the building. U.S. Pat. No. 6,789,647 entitled “Escape mechanism for high-rise” assigned to Yeh, Chi-Hsang on Sep. 14, 2004. In which, a safety facility sleeved into a safety rail with a plurality of staggering pedals is required, while gravity allow the sleeved facility fast slide along a higher safety rail, a leverage action to stop the slippage or stumbling may need a professional life saver to solve the subsequent problems. And a rail seat with a safety belt is only designed for one escapee at a time.

Aforesaid escape mechanisms, active participations are required by users, it is not expected that children, women, senior citizen, and patients can deal with movable window, or a ladder without handrails by handy operation as desired. Negligence in operations may result in more potential risks.

### SUMMARY OF THE INVENTION

Point against aforesaid drawbacks; accordingly, the present invention is to provide an emergency exit window with anti-stealage function comprising a metal grill structure, which is secured to a wall surface of a building, outer face of the grill segment can be formed as a frame without bars, which is adapted to and locked up within the grill structure integrally as whole; a foldable T-type grill (2) includes a spread out T-type grill segment with two pivotal side-doors movably adapted to both sides thereof, the spread out T-type grill (2) is a complement to said frame without bars; but the T-type grill (2) being separated from the frame without bars can be folded and assembled to form a cage-like device; an escape sling (3) comprises a cantilever secured to the wall surface of a building, a deceleration mechanism, and a steel cable having a first end connected to the T-type grill, a second end passed through a pulley of the cantilever connected to the deceleration mechanism.

Said emergency exit window with anti-stealage function wherein an electrical lock or manual lock is secured between top ends of the T-type grill (2) and the metal grill structure.

Said emergency exit window with anti-stealage function wherein a middle fixed portion (21) of the foldable T-type grill (2) close to the wall of the building having a number of positioning holes adapted to a number of positioning studs protruded from the surface of the building.

Said emergency exit window with anti-stealage function wherein an arm (32) of escape sling (3) is extendable.

Said emergency exit window with anti-stealage function wherein three pieces of pivotal doors (22,23,24) surround the perimeter of the middle fixed portion (21) of the foldable T-type grill (2) can be assembled and secured to the fixed portion (21) integrally as a cage like device.

Another embodiment of the present invention is realized by an emergency exit window with anti-stealage function comprising a wall (4) of high-rise building with a recess for receiving a grill structure, a U-type grill (2) includes a glass curtain (25) fixed to the front face or end of the frame (26), wherein the glass curtain (25) is a complement of the recess; but separated from the recess can form a cage-like device; an escape sling (3) including an arm of the cantilever secured to the wall, a deceleration mechanism, and a steel cable having a first end connected to the U-type grill, a second end passed through the pulley of the cantilever connected to the deceleration mechanism.

Said emergency exit window with anti-stealage function wherein the frame (26) is in U shape.

Said emergency exit window with anti-stealage function wherein other than the pivotal doors (22,23,24), a pivotal door can be movably added to the back face of the U shape frame (26).

### COMPARISON TO THE PRIOR ARTS

The merits can be achieved by embodying the present invention as following:

As claimed in claim 1, under panic situation, an escapee scrambles to the grill structure (1) secured to the opening of the building. Meanwhile, an electric lock or manual lock is locked between the top ends of the T-type grill (2) and the grill structure (1); the escapee is still limited in the anti-stealage window, so-called acrophobia can be relieved a little; and then, the escapee only moves to the center of middle fixed portion (21) thereof to get the locks among movable doors (22,23) and the grill structure (1) open, and folds the pivotal doors (22,23) to secure and assemble to the middle fixed portion (21); finally, the escapee protected in the assembled and folded grill (2) gets open a lock between the middle fixed portion (21) and the grill structure (1); the escape sling (3) can be applied to descend the T-type grill (2) slowly from the recess to the ground.

As claimed in claim 2, an electronic lock can be released quickly and effectively, but a manual lock can be released by handy operation no need to worry about a power failure or power deficiency during a blackout.

As claimed in claim 3, the middle fixed portion (21) close to the wall having a number of positioning holes adapted to the positioning studs on the surface of the wall, the middle fixed portion (21) can be fixed to the wall surface in position promptly. Meanwhile, the middle fixed portion (21) can be detached from the wall as well.

As claimed in claim 4, an arm of the cantilever can be extended out of the wall, thereby the foldable T-type grill (2) descended to the ground can be evaded from confrontation with the projected out grill structures of the lower floors tenants.

As claimed in claim 5, three pivotal doors surround the middle fixed portion (21) can improve the safety of the foldable T-type grill (2).

As claimed in claim 6, a high-rise building can be adorned with glass curtain attached to a U type frame (26) at its front end. The integral aesthetics of the appearance of glass curtain can be kept as well.

As claimed in claim 7, a frame (26) formed in U shape integrally can be constructed in simplified structure.

As claimed in claim 8, the perimeter of U shape frame surrounded by at least 3 locked doors can improve the safety of the escapee.

### BRIEF DESCRIPTION OF THE DRAWINGS

FIG. 1 is a perspective view of an emergency exit window with anti-stealage function of the present invention.

FIG. 2. is a schematic view of a spread out T-type grill of the present invention.

FIGS. 3˜4 are schematic views of the T-type grill separated from the grill structure of the present invention.

FIG. 5 is a schematic view of an alternative embodiment of the present invention.

FIG. 6 is a schematic view of the U-type frame adorned with a glass curtain at the front side.

FIGS. 7˜9 are schematic views of the U-type frame in practice adapted to the high-rise building.

### DETAILED DESCRIPTION OF THE PREFERRED EMBODIMENTS

The description is described according to the appended drawings in detail hereinafter.

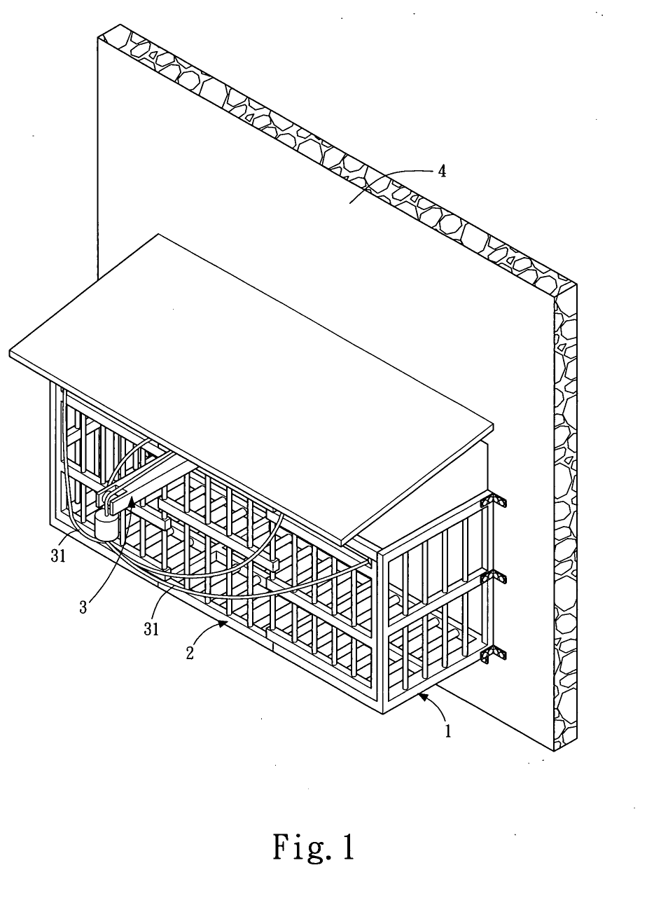

As shown in FIG. 1, an emergency exit window comprising a metal grill structure (1) secured to a wall of a building, a foldable T-type grill (2) movably and pivotally incorporated within the grill structure (1), the T-type grill (2) can be folded as a cage-like device, an escape sling (3) installed in the interior is connected to the T-type grill (2) by a steel cable (31).

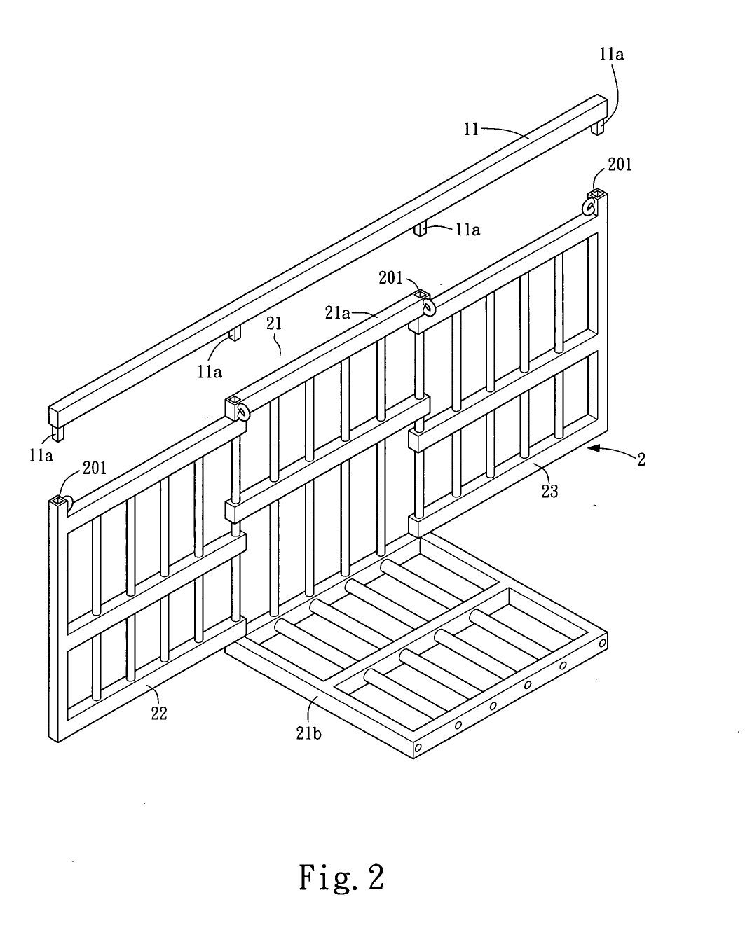

As shown in FIG. 2, the T-type grill (2) is composed of a middle fixed portion (21), (the middle fixed portion (21) consists of a raising frame (21a) in an upright standing position and a leveling frame (21b) in a flat position) and pivotally foldable doors (22,23) on both ends of the T-type grill. Top ends of the foldable doors (22,23) are locked up with the bottom end of a beam (11) of the grill structure (1) by at least two buckled locks (11a), the locks (11a) can be operated electronically or manually. The locks (11a) in usual are led and buckled into the buckle holes (201) on the top ends of the middle fixed portion (21) and both pivotally foldable doors (22,23) at two ends. In use, the buckled locks (11a) are separated from the lock holes (201) by handy or electric operations. Due to the structure of buckled locks (21) and the lock holes (201) are familiar to the persons skilled in the art, which is not the feature of the present invention so that there is no more detailed discussion about them.

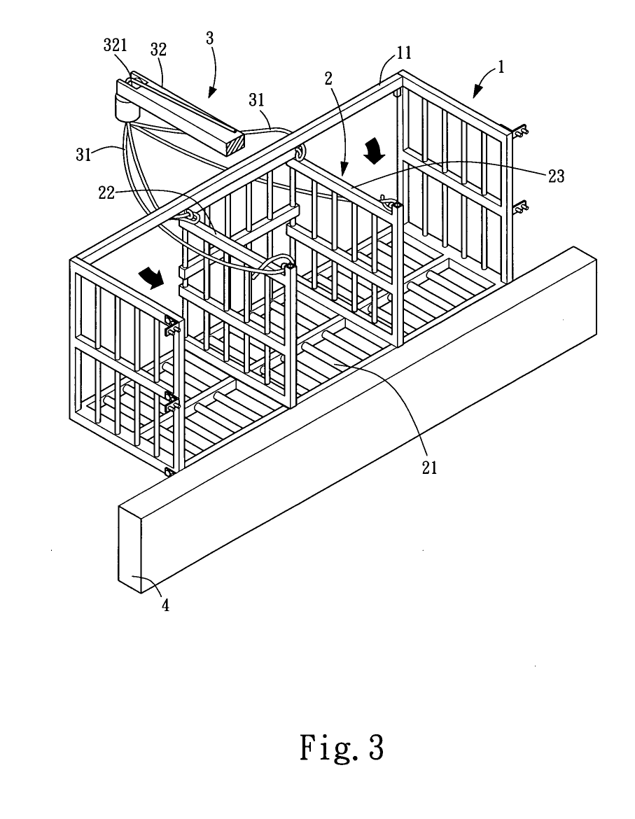

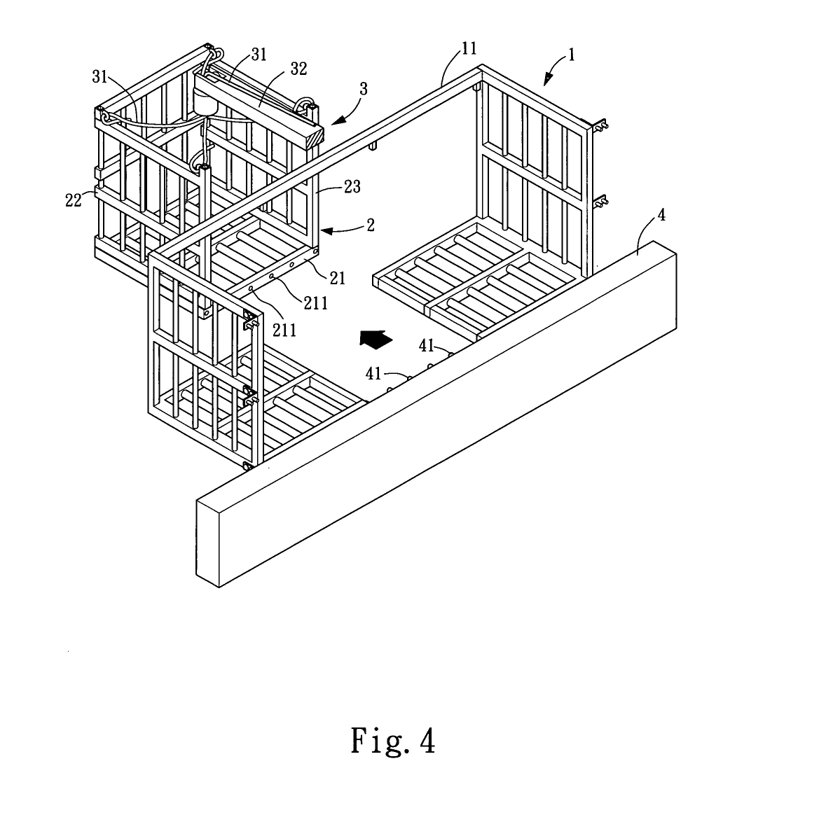

As shown in FIGS. 3˜4, in use, at least two buckled locks among the foldable doors (22,23) and the beam (11) are first released. Due to the raising frame (21a) in an upright standing position is pivotally in connection with foldable doors (22,23) on both left and right sides, foldable doors (22,23) can be folded inwardly at a right angle and then assembled to the leveling frame (21b) to form a cage-like device. Since the assemblage and securing means are familiar to the persons skilled in the art, there is no need to discuss it in detail.

As shown in FIG. 4, at least two buckled locks among the middle fixed portion (21) and the beam (11) are released, an escape sling (3) can be applied to descend the folded grill (2) slowly. Next, a plurality of positioning holes (211) formed on the rear end of the middle fixed portion (21) close to the wall of the building, the positioning holes (211) are corresponding and adapted to a plurality of positioning studs (41) protruded on the surface of the wall of the building. The emergency exit window attached to the building surface in position by studs and holes is firmly to gain the structural solidity.

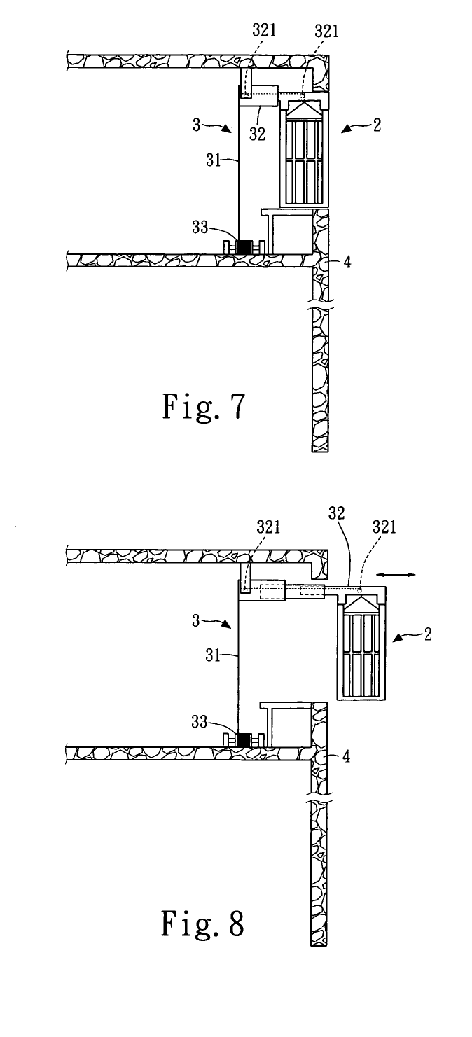

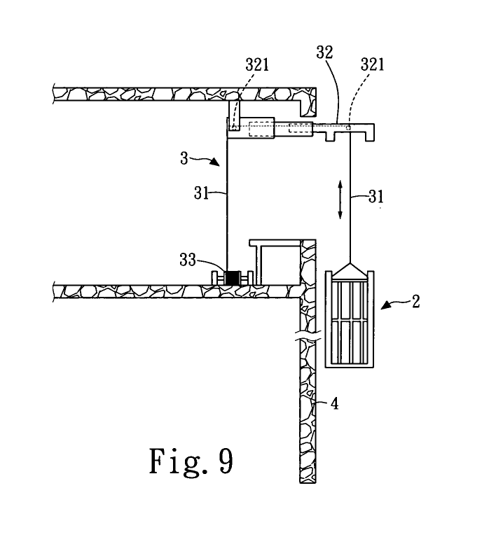

Moreover, an escape sling (3) is composed of an arm (32), a first end of the arm (32) is attached to the wall surface, a second end is used to hang the cage-like device, a deceleration mechanism (33) (as shown in FIGS. 7 and 8) installed inside a recess of the wall, a steel cable (31) having a first end connected to the folded grill (2) by multi-point spot welding, a second end of the steel cable (31) threaded through the arm (32) to adapt to a pulley (321) and then wrapped around the deceleration mechanism (33). In which, the deceleration mechanism (33) can be operated electrically or manually. Like a well-known hoist, the steel cable (31) can be driven to lift or descend objects by a motor rotated in clockwise or counter clockwise direction, therefore, a folded grill (2) is being lifted up from the ground or descended from the window or recess slowly. Owing to the motor used to draw such as a folded grill, the mechanism is familiar to the persons skilled in the art so that the function and mechanism, there is no need to provide more details about it.

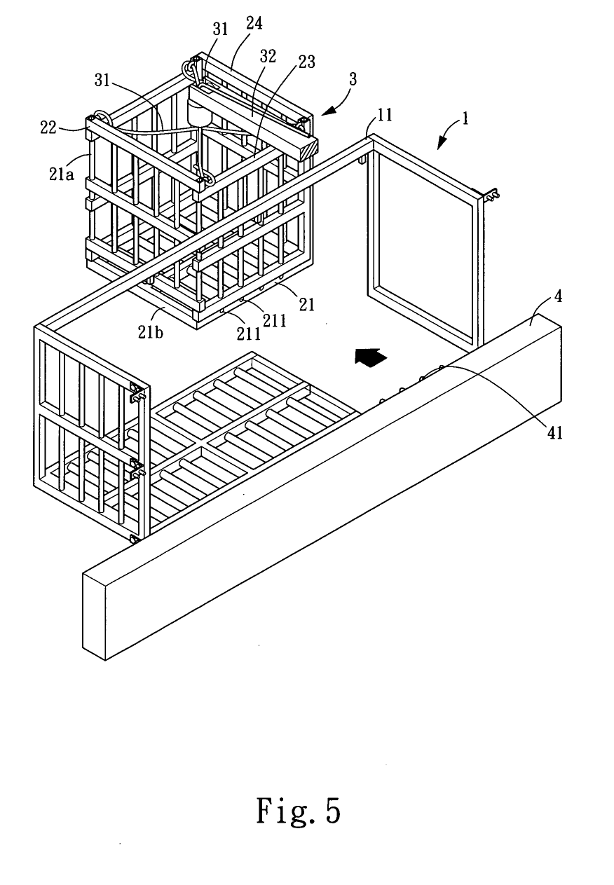

As shown in FIG. 5, an alternative embodiment of the present invention is illustrated. A foldable T-type grill (2) can be disposed to an end of a metal grill structure (1); the T-type grill (2) can also be assembled to and locked up with the grill structure (1) integrally as a whole. As a result, the T-type grill (2) is not only located at the center of the grill structure (1), but also can be located selectively at one of the both ends of the metal grill structure (1). When the grill (2) is spread out, which is identical to the aforesaid metal grill structure (1). But an extra pivotally foldable door (24) can be added to the foldable doors (22,23) to surround middle fixed portion to form a cage like device. Or two pieces of smaller foldable doors (24) (not shown) can be used instead of the one piece of foldable door (24).

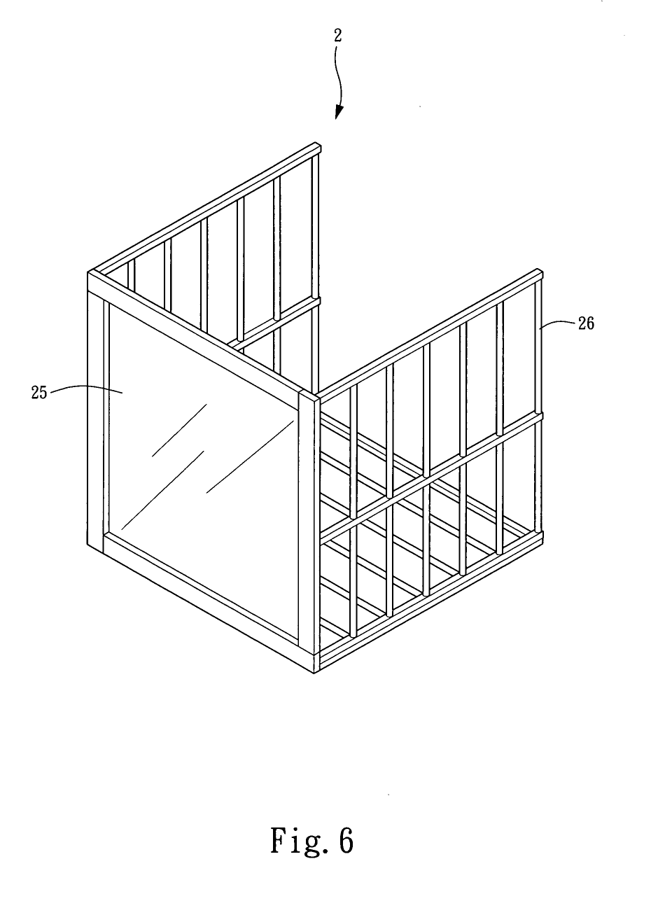

As shown in FIG. 6, a folded grill (2) includes a glass curtain (25) secured to a front end of a U type frame (26). Moreover, a foldable door (not shown) can be added to surround a rear end of the U type frame (26). The escapee in the cage-like device, or a folded grill (2) can be kept safe, because the added foldable door can be applied to seal the emptied rear end of the folded grill (2).

As shown in FIGS. 7˜9, normally, the grill (2) is flush into a recess on the wall of the building. While encountering a panic situation, the extendable arm (32) of the escape sling (3) is extended out from the surface of the wall, and then adapted to the deceleration mechanism through the steel cable to descend the grill (2) to the ground slowly.

What is claim claimed:

1. An emergency exit window with anti-stealage function comprising:
a metal grill structure, which is secured to a wall surface of a building, outer face of the grill segment can be formed as a frame without bars, which is adapted to and locked up within the grill structure integrally as whole;
a foldable T-type grill (2) includes a spread out T-type grill segment with two pivotal side-doors movably adapted to both ends thereof, the spread out T-type grill (2) is a complement to said frame without bars; but the T-type grill (2) being separated from the frame without bars, can be folded and assembled to form a cage-like device;
an escape sling (3) includes a cantilever secured to the wall surface of a building, a deceleration mechanism, and a steel cable having a first end connected to the T-type grill, a second end passed through a pulley of the cantilever connected to the deceleration mechanism.

2. An emergency exit window with anti-stealage function as claim 1 claimed wherein an electrical lock or manual lock is secured between top ends of the T-type grill (2) and the metal grill structure.

3. An emergency exit window with anti-stealage function as claim 1 claimed wherein the rear end of a middle fixed portion (21) of the foldable T-type grill (2) close to the wall of the building having a plurality of positioning holes adapted to a plurality of positioning studs protruded from the surface of the building.

4. An emergency exit window with anti-stealage function as claim 1 claimed wherein an arm (32) of escape sling (3) is extendable.

5. An emergency exit window with anti-stealage function as claim 1 claimed wherein at least three pieces of pivotal doors (22,23,24) surround the perimeter of the middle fixed portion (21) of the foldable T-type grill (2), can be assembled and secured to the middle fixed portion (21) integrally as a cage like device.

6. An emergency exit window with anti-stealage function comprising:
a wall (4) of high-rise building with a recess for receiving a grill structure;
a U-type grill (2) includes a glass curtain (25) fixed to the front end of the frame (26), wherein the glass curtain (25) is a complement of the recess; but separated from the recess can form a cage-like device;
an escape sling (3) including an arm of the cantilever secured to the wall, a deceleration mechanism, and a steel cable having a first end connected to the U-type grill, a second end passed through the pulley of the cantilever connected to the deceleration mechanism.

7. An emergency exit window with anti-stealage function as claim 6 claimed wherein the frame (26) is in U shape.

8. An emergency exit window with anti-stealage function as claim 7 claimed wherein other than the pivotal doors (22,23,24), a pivotal door can be movably added to the back face of the U shape frame (26).
